(19) United States
(12) Patent Application Publication
(10) Pub. No.: US 2023/0110398 A1
(43) Pub. Date: Apr. 13, 2023

(54) METHOD FOR ACQUIRING AN IMAGE OF A CELESTIAL BODY AND APPARATUS FOR IMPLEMENTING THE METHOD

(71) Applicant: UNISTELLAR, MARSEILLE (FR)

(72) Inventors: Arnaud MALVACHE, FUVEAU (FR); Erik VANHOUTTE, MARSEILLE (FR)

(73) Assignee: UNISTELLAR, MARSEILLE (FR)

(21) Appl. No.: 17/911,284

(22) PCT Filed: Mar. 12, 2021
(86) PCT No.: PCT/EP2021/056364

§ 371 Date: Sep. 13, 2022

(30) Foreign Application Priority Data
Mar. 13, 2020 (FR) FR2002481

(51) Int. Cl. H04N 23/45; G02B 23/06; G02B 17/08; H04N 23/61; G02B 7/183

(52) U.S. Cl. CPC H04N 23/45; G02B 23/06; G02B 17/08; H04N 23/61; G02B 7/183

(57) ABSTRACT

A method for acquiring an image of a celestial body, including: using an apparatus including a hollow body into which light rays originating from the observed celestial body penetrate, arranging, in the hollow body, an optical system having an optical axis, the optical system configured so that the light rays form, in an image focal region, an image of the observed celestial body, arranging in the hollow body at least first and second matrix arrays of optical sensors configured to acquire the image of the celestial body formed in the image focal region, where the matrix arrays are of different designs suitable for observing celestial bodies of different natures, selecting one of the matrix arrays and placing it in the image focal region, the other matrix array remaining outside of the image focal region, the matrix array being selected depending on the nature of the observed celestial body.

### TECHNICAL FIELD

The invention relates to a method for acquiring an image of a celestial body. It also relates to image capture apparatus comprising interchangeable sensors for implementing this method.

The invention relates to the technical field of image acquisition and particularly to that of telescopes (or astronomical telescopes).

### STATE OF THE ART

A telescope is intended to observe celestial bodies such as planets, comets, nebulae, galaxies, and generally near or distant celestial objects. Telescopes are used particularly by astronomers, although their use has become widespread in recent years as stargazing has become a passion for many people of different generations. To meet growing consumer demand, manufacturers have had to produce a more diverse range of these instruments to meet the demand of a wider audience.

Users wishing to observe both large (e.g. nebulae, galaxies) and (e.g. planets, moon) celestial bodies need several eyepieces. Changing the eyepiece allows users to adapt the magnification to suit the nature of the celestial body observed. Indeed, large celestial bodies are generally not very bright and observing them requires low magnification. Conversely, smaller celestial bodies are generally brighter and they have to be observed using a higher magnification. In practice, changing eyepieces is particularly inconvenient for users.

Another option for users would be to use at least two separate telescopes. Indeed, in order to obtain the appropriate resolution for each type of celestial body, it is better to use different designs of sensor matric arrays. The pixels are different sizes, depending on the sensor matrix arrays used. Observing large, faint celestial bodies requires the use of relatively large and therefore relatively sensitive pixels (to acquire a large field of view), while observing smaller and brighter celestial bodies can be achieved with smaller and therefore less sensitive pixels (as the acquired field of view is narrower). To have an image of the celestial body with good resolution, users therefore have to choose their telescope according to the nature of the celestial body they wish to observe, which can be restrictive, particularly in cost terms.

An aim of the invention is to overcome the above-mentioned disadvantages.

Another aim of then invention is to offer a technique making it possible to acquire, with a single apparatus, an image of a celestial body, with good resolution, whether the celestial body is large and dark or small and bright.

Yet another aim of the invention is to offer an apparatus for acquiring an image of a large or small celestial body, the design of which is simple, easy to use and inexpensive.

Document US 20150028212 is known in the state of the art; it describes a device seeking to follow the path of a missile by taking a wide shot and a close-up of it, as required. Given its purpose, which is intended to acquire an image of an object travelling in the Earth's atmosphere, such a technical document has nothing in common with the process and the image acquisition apparatus for a celestial body according to the present invention.

### PRESENTATION OF THE INVENTION

The solution proposed by the invention is a method for acquiring an image of a celestial body, comprising the following steps:

using an apparatus comprising a hollow body into which light rays originating from an observed celestial body penetrate in use, said celestial body observed being chosen from among at least a first celestial body of a first nature and a second celestial body of a second nature, the nature of the first celestial body being different from the nature of the second celestial body,

arranging, in the hollow body, an optical system having an optical axis, which optical system is configured so that the light rays form, in an image focal region located in a focal plane, an image of the observed celestial body. The process is noteworthy in that it also comprises the following steps:

arranging, in the hollow body, at least first and second matrix arrays of optical sensors each comprising multiple pixels configured to acquire the image, respectively of the first celestial body and the second celestial body, formed in the image focal region, which matrix arrays respectively have pixels of different sizes from each other,

selecting one of the matrix arrays and placing it in the image focal region, the other matrix array remaining outside of said image focal region, the matrix array being selected depending on the nature of the observed celestial body, either said first celestial body of the first nature or said second celestial body of the second nature.

In the context of the present invention, the expression “celestial body of a different nature” in connection with the first and the second celestial body is understood to mean the fact that these two celestial bodies are of different size and/or brightness. Thus, such a different nature of these two celestial bodies means that each has its own nature, in terms of its size and/or its brightness.

Thus, the nature of the celestial body does not refer here specifically to the fact that the celestial body likely to be observed by the first matrix array and the second matrix array is not identical in terms of celestial object. More specifically and by way of example, it is obvious that two planets of essentially identical size that are not part of the same solar system or the same galaxy are identical celestial objects. However, in the context of the present invention, these two planets will not be considered as celestial bodies of the same nature, given the fact that they do not have the same brightness viewed from the earth.

Regarding the brightness criterion, in relation to the nature of the celestial body considered, this refers to the magnitude of this celestial body, observed from the surface of the earth. It is known that the celestial bodies visible to the naked eye have a magnitude less than 6; for example, the star Vega has a magnitude of 0 and the sun of our solar system a magnitude of -27, for both as observed from the earth's surface. Conversely, the less visible celestial bodies have a magnitude greater than 16.

The magnitude considered for these measurements is most usefully an absolute magnitude or a surface magnitude, well known by an expert, the latter being more relevant for extensive celestial objects such as galaxies or nebulae.

Thus, in the context of the present invention, it is possible to provide multiple matrix arrays, each intended to observe a specific range of magnitudes. By way of an example, the image acquisition system according to the invention comprises four separate matrix arrays:

the first matrix array presenting pixels of a size appropriate to celestial bodies of magnitude between 0 and 6 (upper value included),

the second matrix array presenting pixels of a size appropriate to celestial bodies of magnitude between 6 and 10 (upper value included),

the third matrix array presenting pixels of a size appropriate to celestial bodies of magnitude between 10 and 14 (upper value included), and

the fourth matrix array presenting pixels of a size appropriate to celestial bodies of magnitude greater than 14.

In the remaining part of the presentation of the invention, for purposes of simplification, we consider essentially two different natures of celestial bodies consisting on the one hand of a planet in our solar system considered as a small, very bright celestial body and on the other hand of a nebula, or cluster of galaxies, considered as a large, faint celestial body.

However, the present invention is not limited to defining two natures of celestial bodies, for example by distinguishing small, very bright celestial bodies and large, faint celestial bodies. Thus, the invention can define many more than two natures of celestial bodies—corresponding to as many matrix arrays of optical sensors—to categorise the celestial bodies observed according to their size and/or their brightness. As an example, in FIG. 9, the invention is illustrated with three matrix arrays of optical sensors but the method and the apparatus according to the invention will of course be able to include a greater number of types of celestial bodies observed/matrix arrays of optical sensors.

The use of two different designs of matrix arrays of optical sensors—in this case a different pixel size between the first and the second matrix array at this stage of defining the invention—allows the user to view celestial bodies of different nature with the same apparatus. To acquire, with good resolution, an image of a large faint celestial body, a first matrix array of sensors is selected. The other matrix array of sensors will be selected to acquire the image of a smaller, brighter celestial body, whether the celestial body is large and dark or small and bright. The costs to manufacture, purchase, maintain and handle such an apparatus are thus greatly reduced.

The fact of using two types of interchangeable matrix arrays of optical sensors makes it possible to dispense with the use of two telescopes or different optical systems, to observe large and small celestial bodies. Thus, users are able to select alternately one or other of the sensor matrix arrays, depending on the celestial body they wish to observe.

Other advantageous characteristics of the method described in the invention are listed below. Each of these characteristics can be considered alone or in combination with the noteworthy characteristics defined above. Each of these characteristics contributes, as applicable, to resolving specific technical problems defined below in the description and in which the noteworthy characteristics defined above do not necessarily participate. These latter characteristics may be the subject, where appropriate, of one or more divisional patent applications:

According to one possibility offered by the invention, the first and second matrix arrays extend in the focal plane during all the steps of the method.

In this context, advantageously, the step of selecting one of the matrix arrays takes place by translating one and/or other of the matrix arrays so as to place one of the matrix arrays in the image focal region.

According to another possibility offered by the invention, the step of selecting one of the matrix arrays takes place by rotating one and/or other of the matrix arrays, at least one of the matrix arrays not initially being in the focal plane.

According to one embodiment of the invention, the method comprises the following steps:

fix the matrix arrays on a movable support,

move the movable support to place the selected matrix array in the image focal region.

Advantageously, the method according to the invention comprises the steps consisting of:

motorising the movable support using a motor,

controlling the motor to move the movable support.

Advantageously, the method according to the invention comprises the following steps:

installing the matrix arrays in fixed positions,

using an optical system comprising an optical element that is movable so as to vary the position of the image focal region,

moving the movable optical element so as to bring the image focal region back to the matrix array selected.

Advantageously, the method according to the invention comprises the steps consisting of:

motorising the movable optical element using a motor,

controlling the motor to move the movable optical element.

According to an advantageous aspect of the invention, the method comprises the steps consisting of:

connecting the motor to a processing unit,

controlling the motor:

by activating one or more buttons disposed on the apparatus and connected to the processing unit, or

by transmitting control instructions to the processing unit, which instructions are sent from a smartphone.

According to another advantageous aspect of the invention, the method comprises the steps consisting of:

saving, in a database, records of celestial bodies, each record being associated with one of the matrix arrays and with real-time location data for the celestial body,

selecting, in the database, a celestial body record,

controlling the motor depending on the matrix array associated with the selected record,

automatically orienting the apparatus towards the location of the celestial body, based on the location data associated with the selected record.

According to another advantageous aspect of the invention, the method comprises the steps consisting of:

acquiring an image of a celestial body observed in an observation scene, which acquisition is carried out by means of one of the matrix arrays selected according to the nature of said celestial body,

executing a computerised process configured to detect the movement of another celestial body in the observation scene,

selecting the other matrix array,

controlling the motor according to the other matrix array selected.

According to another advantageous aspect of the invention, the method comprises the steps consisting of:

saving, in a database, records of celestial bodies, each record being associated with one of the matrix arrays and at least one characteristic element of the celestial body,

acquiring an image of a celestial body, which acquisition is carried out by means of one of the matrix arrays,

executing a computerised recognition process configured to detect, in the image acquired, at least one characteristic element of said celestial body,

identifying, in the database, a record of a celestial body associated with a characteristic element similar to that detected,

selecting the matrix array associated with the record identified,

if the matrix array that acquired the image does not match the matrix array selected, then controlling the motor according to said selected matrix array.

According to one possibility offered by the invention, the first and second matrix arrays extend in the focal plane during all the steps of the method.

In this context, advantageously, the step of selecting one of the matrix arrays takes place by translating one and/or other of the matrix arrays so as to place one of the matrix arrays in the image focal region.

According to another possibility offered by the invention, the step of selecting one of the matrix arrays takes place by rotating one and/or other of the matrix arrays, at least one of the matrix arrays not initially being in the focal plane.

According to one embodiment of the invention, the method comprises the following steps:

fix the matrix arrays on a movable support,

move the movable support to place the selected matrix array in the image focal region.

Advantageously, the method according to the invention comprises the steps consisting of:

motorising the movable support using a motor,

controlling the motor to move the movable support.

Advantageously, the method according to the invention comprises the following steps:

installing the matrix arrays in fixed positions,

using an optical system comprising an optical element that is movable so as to vary the position of the image focal region,

moving the movable optical element so as to bring the image focal region back to the matrix array selected.

Advantageously, the method according to the invention comprises the steps consisting of:

motorising the movable optical element using a motor,

controlling the motor to move the movable optical element.

According to an advantageous aspect of the invention, the method comprises the steps consisting of:

connecting the motor to a processing unit,

controlling the motor:

by activating one or more buttons disposed on the apparatus and connected to the processing unit, or

by transmitting control instructions to the processing unit, which instructions are sent from a smartphone.

According to another advantageous aspect of the invention, the method comprises the steps consisting of:

saving, in a database, records of celestial bodies, each record being associated with one of the matrix arrays and with real-time location data for the celestial body,

selecting, in the database, a celestial body record,

controlling the motor depending on the matrix array associated with the selected record,

automatically orienting the apparatus towards the location of the celestial body, based on the location data associated with the selected record.

According to another advantageous aspect of the invention, the method comprises the steps consisting of:

acquiring an image of a celestial body observed in an observation scene, which acquisition is carried out by means of one of the matrix arrays selected according to the nature of said celestial body,

executing a computerised process configured to detect the movement of another celestial body in the observation scene,

selecting the other matrix array,

controlling the motor according to the other matrix array selected.

According to another advantageous aspect of the invention, the method comprises the steps consisting of:

saving, in a database, records of celestial bodies, each record being associated with one of the matrix arrays and at least one characteristic element of the celestial body,

acquiring an image of a celestial body, which acquisition is carried out by means of one of the matrix arrays,

executing a computerised recognition process configured to detect, in the image acquired, at least one characteristic element of said celestial body,

identifying, in the database, a record of a celestial body associated with a characteristic element similar to that detected,

selecting the matrix array associated with the record identified,

if the matrix array that acquired the image does not match the matrix array selected, then controlling the motor according to said selected matrix array.

Another aspect of the invention relates to an apparatus for acquiring an image of a celestial body, comprising:

a hollow body into which light rays originating from an observed celestial body penetrate in use, said celestial body observed being chosen from among at least a first celestial body of a first nature and a second celestial body of a second nature, the nature of the first celestial body being different from the nature of the second celestial body,

an optical system arranged in the hollow body and having an optical axis, which system is configured so that the light rays form, in an image focal region located in a focal plane, an image of the observed celestial body.

The apparatus is noteworthy in that it comprises:

at least first and second matrix arrays of optical sensors each comprising multiple pixels configured to acquire the image, respectively of the first celestial body and the second celestial body, formed in the image focal region, which matrix arrays respectively have pixels of different sizes from each other,

a device for selecting appropriate matrix arrays to place one of the two matrix arrays in the image focal region, the other matrix array remaining outside said image focal region, so that the celestial body observed is the first celestial body of first nature or the second celestial body of second nature.

In the context of the present invention, the fact that the two matrix arrays of optical sensors have different sizes of pixels does not exclude that within the same matrix array—for example the first or the second matrix array—the pixels are not of identical size.

In this case, the average size of the pixels of a matrix array is considered as defining the size of the pixels and the expression “average size” is defined as signifying the different sizes of pixels present in the matrix array considered, weighted by their number in the matrix array. As an example, if we consider that a matrix array comprises ten pixels, five pixels of which are size z₁ and five pixels size z₂, then the average size of the pixels of the matrix array equals: [z₁×(5/10)]+[z₂×(5/10)].

Other advantageous characteristics of the apparatus described in the invention are listed below. Each of these characteristics can be considered alone or in combination with the noteworthy characteristics defined above. Each of these characteristics contributes, as applicable, to resolving specific technical problems defined below in the description and in which the noteworthy characteristics defined above do not necessarily participate. These latter characteristics may be the subject, where appropriate, of one or more divisional patent applications:

According to one particularly interesting aspect of the invention, the first matrix array and the second matrix array are different sizes.

In its broadest acceptance, the present invention is defined by a first matrix array of optical sensors having pixels of sized differently from those in the second matrix array.

However, given the specific nature of the optical observation specified in the context of the present invention, a range of pixel sizes can be defined, irrespective of the number of natures of celestial bodies to be observed, and therefore corresponding matrix arrays of optical sensors. In the same way, a range of pixel numbers per matrix array and a range of matrix array sizes can be defined.

Thus, advantageously, the pixels of the (first and second) matrix arrays of optical sensors are between 0.1 μm and 20 μm in size, preferably between 0.5 μm and 10 μm. The term “size”, in relation to a pixel, is understood to mean the fact that one side of a pixel—conventionally square-shaped—has the defined size.

Advantageously, the number of pixels in the (first and second) matrix arrays of optical sensors is between 10⁵ pixels (one hundred thousand pixels) and 10⁹ pixels (one billion pixels), preferably between 10⁶ (one million) and 10⁸ (one hundred million) pixels.

Advantageously, the (first and second) matrix arrays are between 1 square millimetre (mm ²) and 1000 mm ² in size, preferably between 5 mm ² and 150 mm ².

According to one possibility offered by the invention, the image focal region is fixed and the matrix arrays are movable.

Advantageously, the matrix arrays are fixed on a support that is movable between:

a first position in which the first matrix array is placed in the image focal region, and in which the second matrix array is placed outside said image focal region,

a second position in which the second matrix array is placed in the image focal region, and in which the first matrix array is placed outside said image focal region.

Advantageously, the support is movable by rotation or movable by translation.

According to another possibility offered by the invention, the matrix arrays are fixed and the image focal region is movable.

Advantageously, the optical system comprises an optical element that is movable so as to vary the position of the image focal region.

According to one aspect of the invention, the optical element is movable between:

a first position in which the image focal region is brought back to the first matrix array,

a second position in which the image focal region is brought back to the second matrix array.

Advantageously, the optical system comprises:

a primary mirror positioned in the hollow body, to reflect the light rays entering said body,

a secondary mirror positioned in the hollow body to reflect the light rays reflected by the primary mirror, which secondary mirror is adjusted to bring the focal plane behind the primary mirror,

the matrix arrays are arranged behind the primary mirror.

According to one embodiment, the apparatus is presented in the form of a telescope.

### BRIEF DESCRIPTION OF FIGURES

Other advantages and characteristics of the invention will become clearer in the description of a preferred embodiment below, with reference to the appended drawings, produced by way of non-limitative examples for guidance, wherein:

FIG. ais a cross-sectional schematic view showing an image capture apparatus according to the invention, comprising matrix arrays of interchangeable sensors according to a first embodiment, in a first observation position.

FIG. 1 b shows the apparatus of FIG. 1a, in a second observation position.

FIG. 2 schematic diagram of a movable support, front view, on which matrix arrays of interchangeable sensors are installed, according to a first embodiment.

FIG. 3a is a cross-sectional schematic view showing an image capture apparatus according to the invention, comprising matrix arrays of interchangeable sensors according to a second embodiment, in a first observation position.

FIG. 3b shows the apparatus of FIG. 3a, in a second observation position.

FIG. 4a is a cross-sectional schematic view showing an image capture apparatus according to the invention, comprising matrix arrays of interchangeable sensors according to a third embodiment, in a first observation position.

FIG. 4b shows the apparatus of FIG. 4a, in a second observation position.

FIG. 5a is a cross-sectional schematic view showing an image capture apparatus according to the invention, comprising matrix arrays of interchangeable sensors according to a fourth embodiment, in a first observation position.

FIG. 5b shows the apparatus of FIG. 5a, in a second observation position.

FIG. 6 is a cross-sectional schematic view showing an image capture apparatus according to the invention, comprising matrix arrays of interchangeable sensors according to a fifth embodiment, in an observation position.

FIG. 7 is a cross-sectional schematic view showing an image capture apparatus according to the invention, comprising matrix arrays of interchangeable sensors according to a sixth embodiment, in an observation position.

FIG. 8 is a cross-sectional schematic view showing an image capture apparatus according to the invention, comprising matrix arrays of interchangeable sensors according to a seventh embodiment, in an observation position.

FIG. 9 is a cross-sectional schematic view showing an image capture apparatus according to the invention, comprising matrix arrays of interchangeable sensors according to a eighth embodiment, in an observation position.

FIG. 10 is a cross-sectional schematic view showing an image capture apparatus according to the invention, comprising matrix arrays of interchangeable sensors according to a ninth embodiment, in an observation position.

### DESCRIPTION OF EMBODIMENTS

For purposes of clarity, the present invention makes reference to one or more “computerised processes”. The latter correspond to the actions or results obtained by the execution of instructions from different computer applications. It must also be understood in the scope of the invention, that “a computerised process is adapted to do something” means “the instructions of a computerised application executed by a processing unit do something”.

Such as used here, unless otherwise specified, the use of the ordinal adjectives “first”, “second”, etc., to describe an object simply indicates that different occurrences of similar objects are mentioned and does not imply that the objects thus described must be in a given sequence, whether in time, space, ranking or otherwise.

The apparatus 30, subject of the invention, is used for observing both large celestial bodies and small celestial bodies. These celestial bodies or celestial objects can be planets, stars, nebulae, galaxies, etc. It is preferably a telescope but the apparatus can also take the form of a photographic apparatus or a video camera. For purposes of clarity, and only as an illustrative example, the remaining part of the description refers only to a telescope suitable for observing celestial bodies of different natures, in particular small relatively bright celestial bodies 50 (e.g. planets, moon) and large, darker celestial bodies 51 (e.g. nebulae, galaxies).

In the appended figures, the telescope 30 particularly comprises a hollow body 302 inside which light rays 34 originating from the observed celestial body 50, 51 penetrate in use. The hollow body 302 has a first end 300 through which the light rays 34 penetrate and a second end 301 opposite said first end.

The hollow body 302 is presented preferably in the form of a hollow tube circular in cross-section, but could be a tube with oval, square, octagonal or other cross-section. It is specified that the hollow body 302 is not necessarily tubular in shape, but may be conical in shape or formed, for example, from portions of tubes or cones. The hollow body 302 can be made of plastic or composite material, etc. As an example, it is between 200 mm and 400 mm long, between 50 mm and 500 mm in diameter and between 1 mm and 10 mm thick.

An optical system 31, 382, 383 is arranged in the hollow body 302 having an optical axis 32. The optical system is configured so that the light rays 34 form, in a focal plane 33, an image of the observed celestial body 50, 51.

The telescope has an optical axis 32. Within the meaning of the present invention, optical axis means the line that passes through the centre of each optical element of the optical system 31, 382, 383. The optical axis 32 is a rectilinear axis coinciding with the axis of symmetry of the telescope 30 (as, for example, in the first, second, fifth, seventh, eighth and ninth embodiments). However, other configurations are possible, in which the optical axis 32 is non-rectilinear and is made up of a principal optical axis (coinciding with the axis of symmetry) and by a secondary optical axis (between a movable mirror 381 and a matrix array of sensors 361, 362, 363); for example, this type of configuration is represented in the third, fourth and sixth embodiments.

The telescope has an image focal region 330 at the intersection between the optical axis 32 and the light rays 34. The image focal region 330 is preferably in the focal plane 33.

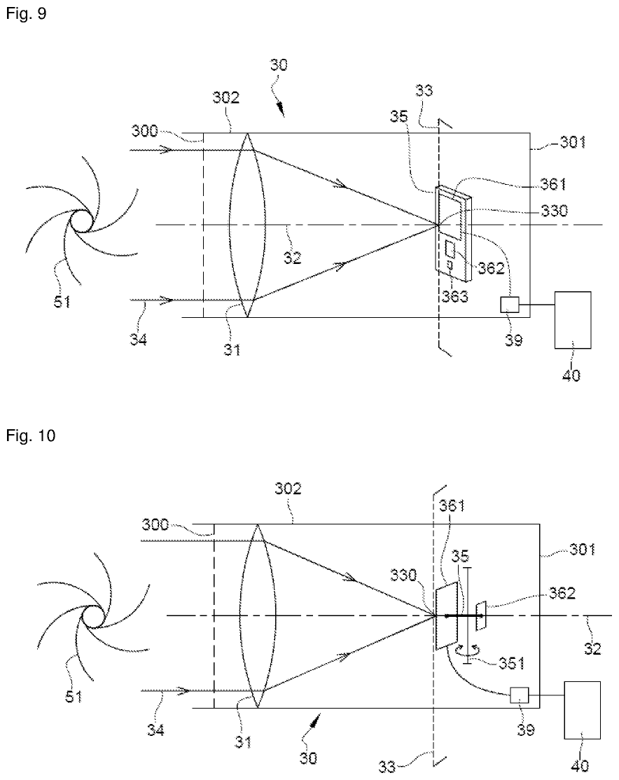

In the hollow body 302 are arranged at least two matrix arrays of optical sensors 361, 362 configured to acquire the image of the observed celestial body 50, 51, formed in the image focal region 330. It is also possible to envisage three matrix arrays of optical sensors (as represented in FIG. 9) or more, making it possible to obtain a wider range of resolution such that users can observe a larger category of celestial bodies (for example, celestial bodies of intermediate sizes, or very large celestial bodies such as the Andromeda Galaxy), but also to refine the resolution according to the nature of the celestial body observed.

The first matrix array 361 and the second matrix array 362 have different designs so as to be suitable to observe different natures of celestial bodies 50, 51.

For example, the matrix arrays 361, 362 are made up of CCD (Charged Coupled Device) or CMOS (Complementary Metal Oxide Semiconductor) sensors, as this type of matrix array is smaller, making it possible to install them easily in the apparatus 30. They consist of an arrangement of optical sensors, each sensor being in the form of a pixel. These pixels have different sizes and resolutions depending on the matrix array 361, 362 in which they are fitted. Each type of matrix array is appropriate to a type of celestial body to be observed. The matrix arrays are characterised by their size, the size of pixels and the number of pixels. The size of the matrix array influences the field of view. The size of pixels and their number influence the resolution and sensitivity.

The size of the matrix array determines the field of view. In fact, the larger the matrix array, the wider the portion of sky observed. It will therefore be possible to observe extensive celestial bodies such as nebulae or celestial bodies in the deep sky. Conversely, with a smaller matrix array, the portion of sky observed will be more reduced. With a restricted field of view, we can only observe smaller celestial bodies such as planets.

In the remaining part of the description, the first matrix array 361 is considered as being the largest and suitable for observing large celestial bodies 51. For example, it surface area is between 50 mm ² and 150 mm ². The second matrix array 362 is considered as being the smallest and suitable for observing small celestial bodies 50. For example, it surface area is between 5 mm ² and 15 mm 2.

These particularly compact matric arrays 361, 362 are easily integrated into the hollow body 302.

The optical resolution of the telescope 30 is generally defined by the size of the mirror or lens of the optical system 31. The size of the pixels in the matrix array of sensors determines the digital resolution of the image observed and indirectly the possibility of zooming in. In fact, the smaller the pixels get, the more the digital resolution increases. And by increasing the digital resolution, it is possible to achieve good quality enlargement of one part of the observed image. Conversely, if the digital resolution is low, the enlargement will be poor quality. The resolution of the digital telescope is determined by the least resolved element between the optics and the sensor matrix array. There is therefore no benefit in using pixels smaller than the optical resolution of the telescope 30.

Pixel size also affects sensitivity to light. Small pixels are less sensitive.

Conversely, large pixels are more sensitive. If the user observes a small celestial body 50, such as a very bright planet, high sensitivity is not required. Small celestial bodies 50 can therefore be observed with small, low sensitivity pixels such that one concentrates on the digital resolution that enables details of the planet surface (e.g. storms, craters, etc.) to be observed. Conversely, if the user observes a large celestial body 51, such as a faint nebula, it is advantageous to have high light sensitivity. Since these celestial bodies are large, very high resolution is not needed to observe details (gas clouds, galaxy arms).

According to one embodiment, for example, small pixels have sides between 0.5 μm and 2 μm long. Large pixels, for example, have sides between 2 μm and 10 μm long.

Each matrix array 361, 362 is preferably a CCD (Charged Coupled Device) or CMOS (Complementary Metal Oxide Semiconductor) sensor comprising an arrangement of pixels (preferably generating colour images). This type of matrix array is smaller and therefore easier to install.

The first matrix array 361 comprises large pixels and the second matrix array 362 has small pixels. The telescope 30 therefore enables, by itself, optimal observation of both small bright celestial bodies 50, for which good numerical resolution is desired, and large darker celestial bodies 51, for which good light sensitivity is desired.

The optical sensors of matrix arrays 361, 362 are photosensitive components, making it possible to generate data (or electrical signals) as a result of acquiring the image of the celestial body 50, 51 in the image focal region 330. The electrical signals generated by the optical sensors are transmitted to an electronic image processing unit 39. The connection between the matrix arrays 361, 362 and the unit 39 can be cabled or wireless, for example according to a proximity communication protocol, examples such as but non-limited to the Bluetooth®, Wifi ® or Zigbee® protocol. The first matrix array 361 and the second matrix array 362 are both connected to the same unit 39 and the data obtained from the two said matrix arrays are observed on the same screen 40.

The unit 39 comprises a computer in the form of a processor, microprocessor or CPU (Central Processing Unit), a memory and data processing resources in general to process electrical signals received from matrix arrays 361, 362 to form a digital image of the celestial body. These components are preferably mounted on an electronic card, making it possible to group all the electronic components of unit 39 together in one place and on a single board. This design minimises the number of electronic cards built into the telescope 30, and reduces the number of wires. In addition, manufacturing the unit 39, installing it the telescope 30 and, if necessary, maintaining it are thereby greatly facilitated.

The digital image generated by the unit 39 is displayed on a screen 40. The screen 40 can be mounted on the electronic card, such that the unit 39 and said screen form an easily-handled one-piece assembly. In this case, a flat screen is advantageously used, for example a polychrome LCD (Liquid Crystal Display) or OLED (for Organic Light-Emitting Diode) screen.

According to another embodiment, the screen 40 is separate from the unit 39 and the electronic card. It is physically distant from the hollow body 302. In this embodiment, the screen 40 can be that of the user's mobile terminal, for example the screen of a smartphone or touchscreen tablet. The unit 39 and the screen 40 can be connected by a wired link (e.g. using a USB cable) or wirelessly, for example according to a proximity communication protocol, examples such as but non-limited to the Bluetooth®, Wifi® or Zigbee® protocol. This embodiment makes it possible for the telescope 30 to be more compact, since the size of the screen 40 is not considered.

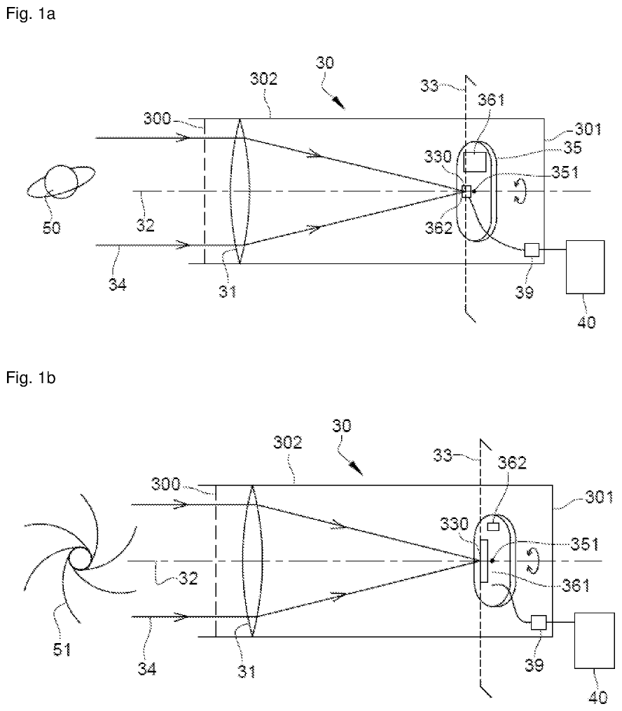

### First Embodiment (FIGS. 1a and 1b)

In this embodiment, the image focal region 330 is fixed and the matrix arrays 361, 362 are movable by rotation. The image focal region 330 here is perpendicular to the axis of symmetry of the hollow body 302, which axis coincides with the optical axis 32.

In FIGS. 1a and 1b, the optical system comprises a lens 31 arranged inside the hollow body 302 and centred on the optical axis 32. The light rays 34 are refracted by the lens 31 to form, in the image focal region 330, an image of the celestial body 50, 51 observed. The shape and dimensions of said lens are appropriate to those of the hollow body 302. The operation of the telescope 30 is identical to that described with reference to the first embodiment.

The first matrix array 361 and the second matrix array 362 are fixed on a movable support 35 installed in the hollow body 302, close to the second end 301.

The movable support 35 is made, for example, of steel, carbon, or plastic, such that its design is simple, inexpensive and long-lasting. The movable support 35 is preferably circular in shape but can also be square, octagonal, oval, etc. In general, the shape and dimensions of the movable support 35 are appropriate to the dimensions of matrix arrays 361, 362. By way of example, its surface area is between 2 cm ² and 8 cm ². These reduced dimensions enable a minimum of space inside the apparatus 30 to be used.

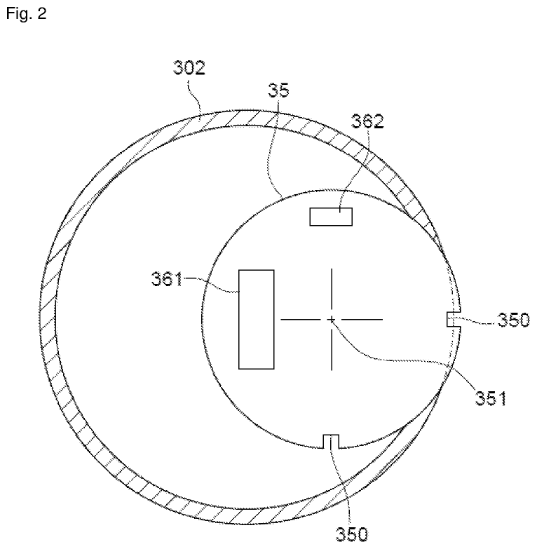

The movable support 35 represented in FIG. 2 is in the form of a movable wheel that rotates around an axis of rotation 351. This latter axis is in the focal plane 33 and perpendicular to the optical axis 32. The wheel may be circular, oval, square, rectangular, etc. The movable support 35 has at least two arrangements to house the matrix arrays 361, 362.

The position of the support 35 for observing a small celestial body 50 is illustrated in FIG. 1a and that for observing a large celestial body 51 is illustrated in FIG. 1b.

When the user observes a small celestial body 50, the movable support 35 is arranged so that the second matrix array 362 is placed in the image focal region 330 (it is understood within the meaning of the present invention that its photosensitive face is in the image focal region). The first matrix array 361 remains placed in the focal plane 33 but outside the image focal region 330. The second matrix array 362 is said to be “active” and the first matrix array 361 “inactive”.

When the user observes a large celestial body 51, the movable support 35 is arranged such that the first matrix array 361 is placed in the image focal region 330 (the first matrix array is active). The second matrix array 362 remains placed in the focal plane 33 but outside the image focal region 330 (the second matrix array is inactive). The selected matrix array 361, 362, by the movable support 35, is thus activated depending on the nature of the celestial body 50, 51 observed.

The selected matrix array 361 or 362 is activated by pivoting the support 35 around its axis of rotation 351. The support 35 is therefore movable between at least two positions: a first position where the first matrix array 361 is active and a second position where the second matrix array 362 is active. The movable support 35 can also have a third and/or a fourth position depending on the number of matrix arrays used.

According to one embodiment, the selected matrix array 361 or 362 is activated manually by the user who pivots the movable support 35 into the desired position. In FIG. 2, the movable support 35 is inserted into the apparatus 30 with an accessible part that protrudes from the hollow body 302. By manipulating this accessible part, the user can rotate the support 35 manually, clockwise or anticlockwise, so as to activate one or other of the matrix arrays 361, 362. To facilitate this rotation, the support 35 is presented advantageously in the form of a thumb wheel. So that the user knows which matrix array 361, 362 is in use, the movable support 35 advantageously has a system of marks 350 on its circumference, as illustrated in FIG. 2. The marks can, for example, take the form of different sized notches or markings (colours, numbers, etc.).

According to another embodiment, the movable support 35 is motorised by means of a motor and can, in this case, be fully integrated within the apparatus 30. The motor for movable support 35 is, for example, connected to the processing unit 39. This controls the motor to move the movable support 35 into the first position or into the second position, depending on the matrix array to be activated. The position of the movable support 35 is then changed semi-automatically, for example following the operation of one or more buttons disposed on the apparatus 30 and connected to the processing unit 39.

The motor of the movable support 35 can also be controlled by sending command instructions transmitted from the user's Smartphone to the processing unit 39. These instructions are, for example, issued after operating one or more dedicated buttons displayed on the Smartphone's graphic interface. In this case, the Smartphone is suitable for communicating with the processing unit 39 and transmitting the command instructions to it, for example via a Wifi® or Bluetooth® connection. Upon receiving these command instructions, the processing unit 39 controls the motor of the movable support 35 to activate the selected matrix array 361 or 362.

According to yet another embodiment, the motor of the movable support 35 is controlled automatically. The selected matrix array 361 or 362 is then activated without action by the user. Various cases of automatic activation may be presented. The cases presented below do not limit the scope of the invention, other uses may be envisaged.

In a first case, the user points the telescope 30 towards an observation field of the celestial sphere. The processing unit 39 is connected to a database in which the main celestial bodies known to experts are recorded. This database can be integrated into the telescope 30. In a variant embodiment, the database is remote from the telescope 30, for example hosted in a remote server to which the processing unit 39 is connected. In this case the unit 39 can be connected to the database through an internal type of communication network, 3G, 4G, 5G, etc.

Each record of a celestial body is associated, in the database, with the matrix array 361, 362 best suited to observing said celestial body, for example depending on its size, brightness and/or an optimal digital resolution. Each record is also preferably associated:

with one or more characteristic elements of the corresponding celestial body, such as its size, pattern, brightness, etc.; and/or

with real-time location data (or celestial coordinates) of said celestial body.

The user selects a celestial body record in the database and the telescope 30 will point itself at said celestial body. The processing unit 39 reads a time data point t corresponding to the acquisition period, i.e. the moment when the user selects the record in the database. The processing unit 39 then searches the database for the celestial coordinates of the celestial body at time t. By correlating the terrestrial location data of the telescope 30, for example by means of GPS (Global Positioning System) and the orientation data of said telescope, for example using an accelerometer, the processing unit 39 actuates an on-board motorised device enabling said telescope to be oriented automatically towards the location of the selected celestial body 50, 51. The processing unit 39 also controls the motor to move the support 35 into the position enabling the matrix array associated with the selected record that is best suited for to observing this celestial body to be activated. The image can then be acquired optimally.

In a second case, the user observes a celestial body and acquires its image with activation of the optimum matrix array 361, 362 to observe this celestial body. Another celestial body moves in the field of view (or observation scene). For example, the user observes a small celestial body 50 (a planet) with the second matrix array 362 active. An asteroid then passes into the field of view. The processing unit 39 executes a computerised process configured to detect the passage of the other celestial body into the observation scene. This process is based, for example, on motion detection. It may then be advantageous to zoom out to enlarge the observation scene and observe the asteroid for longer. The first matrix array 361 is then selected. The processing unit 39 will then control the motor to move the support 35 into the position enabling the first matrix array 361 to be activated and the second matrix array 362 to be deactivated. The matrix array can also be changed automatically when the user initially observes a large celestial body 51 (with the first matrix array 361 active) and it is advantageous to zoom in to restrict the observation scene (activation of the second matrix array 362).

In a third case, when the user points the telescope 30 towards a particular celestial body 50, 51, one of the matrix arrays 361, 362 acquires the image of said celestial body. The image acquired is then analysed by the processing unit 39. This analysis is carried out by executing a computerised recognition process configured to detect at least one characteristic element, for example by implementing a thresholding analysis. If necessary, an expert may refer in particular to the patent documents FR3054897 and/or US2019196173 for more details on such a computerised recognition process. Once the particular characteristic element has been detected, the processing unit 39 identifies, in the database, a celestial body record associated with a characteristic element similar to that detected. As soon as a similar characteristic element is detected, the record for the corresponding celestial body is identified, as well as the matrix array 361, 362 associated with this record.

The processing unit 39 selects the matrix array associated with the record and sends a command instruction to the motor of the movable support 35 to activate said corresponding matrix array. If the matrix array 361, 362 that acquired the image is the correct one, it remains active and the support 35 does not move. Conversely, if the matrix array 361, 362 that acquired the image is not the correct one, then the processing unit 39 controls the motor to move the support 35 into the position activating the other matrix array. The image can then be acquired optimally.

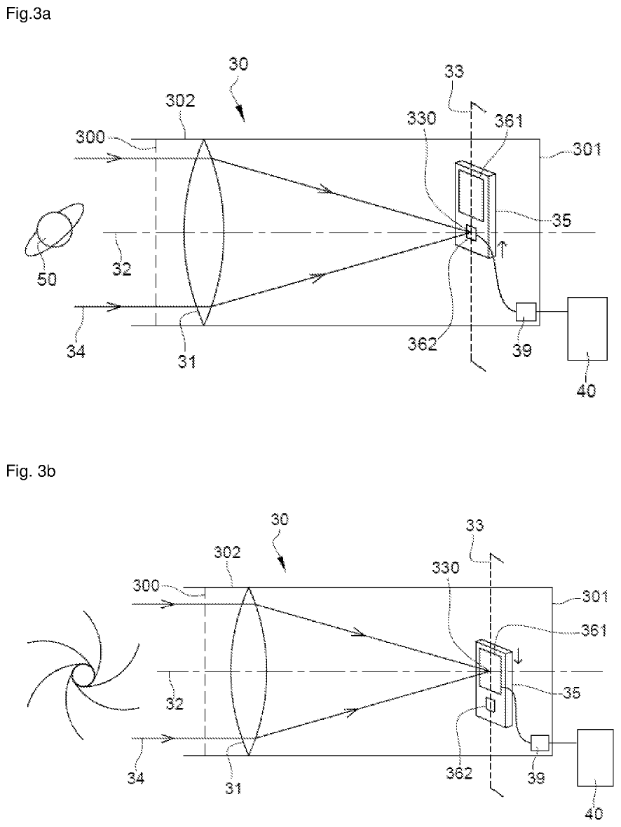

### Second Embodiment (FIGS. 3a and 3b)

In this embodiment, the image focal region 330 is fixed and the matrix arrays 361, 362 are movable by translation.

The movable support 35 is, for example, in the form of a plate or a section on which the matrix arrays 361, 362 are fixed. These arrays are arranged in the focal plane 33. The movable support 35 is advantageously mounted on a slide rail so as to guide its translational movement.

The selected matrix array 361 or 362 is then activated by causing the support 35 to translate between at least two positions:

a first position in which the first matrix array 361 is active (placed in the image focal region 330) and the second matrix array 362 inactive (placed in the focal plane 33 and outside the image focal region 330).

a second position in which the second matrix array 362 is active (placed in the focal plane 33 and in the image focal region 330) and the first matrix array 361 inactive (placed in the focal plane 33 and outside the image focal region 330).

The movable support 35 can also have one or more other positions depending on the number of matrix arrays used.

As previously described by reference to the first embodiment, the selected matrix array 361 or 362 can be activated by moving the movable support 35 manually, or by moving it semi-automatically or automatically by motorising said support. The methods for controlling the motor are identical to those previously described by reference to the first embodiment.

The apparatus 30 is operated in a similar way to that previously described by reference to the first embodiment.

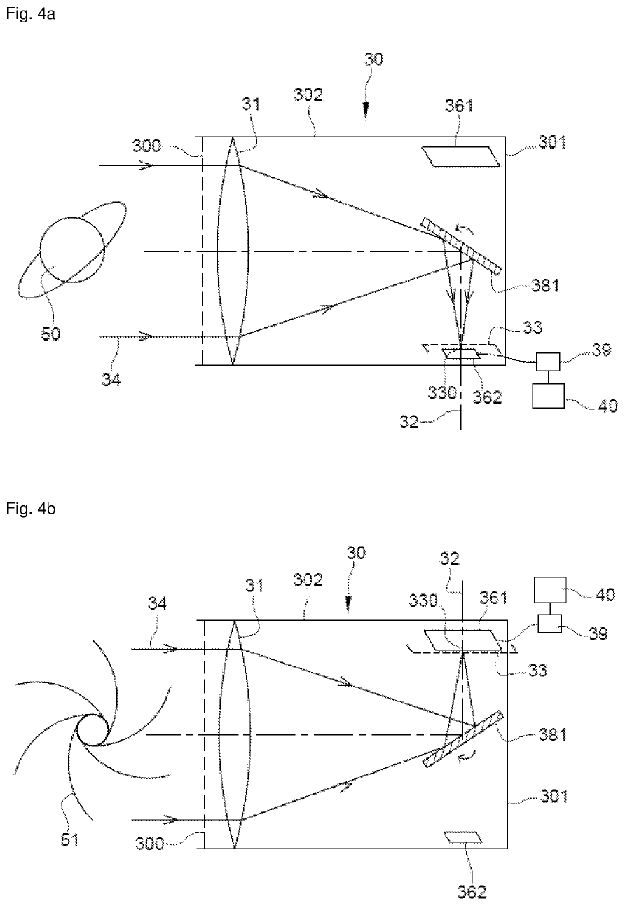

### Third Embodiment (FIGS. 4a and 4b)

In this embodiment, the image focal region 330 is movable and the matrix arrays 361, 362 are fixed.

The optical system here presents a movable optical element 381 adapted to vary the position of the image focal region 330. In FIGS. 4a and 4b, the matrix arrays 361, 362 are installed in fixed positions in the hollow body 302, symmetrically with respect to the axis of symmetry of said body. In other words, the matrix arrays 361, 362 are each disposed on one side of the hollow body 302.

The movable optical element 381 advantageously takes the form of a flat mirror mounted so as to be movable by rotation about a horizontal axis passing through the optical centre of said mirror. By varying the inclination of the mirror 381, the light rays 34 refracted by the lens 31 are deflected, such that the image focal region 330 is brought back to the first matrix array 361 or the second matrix array 362.

In a first inclined position of the mirror 381 (FIG. 4b), the first matrix array 361 is active (placed in the image focal region 330) and the second matrix array 362 inactive (placed outside the image focal region 330). In a second inclined position of the mirror 381 (FIG. 4a), the second matrix array 362 is active (placed in the image focal region 330) and the first matrix array 361 inactive (placed outside the image focal region 330). The mirror 381 may have one or more other inclined positions depending on the number of matrix arrays used. It is therefore that by moving the mobile optical element 381 that the selected matrix array 361 or 362 is activated.

More generally, to activate the selected matrix array, the movable optical element 381 is moved so as to bring the image focal region 330 back to said matrix array.

As previously described by reference to other embodiments, the selected matrix array 361 or 362 can be activated by moving the mirror 381 manually, or by moving it semi-automatically or automatically by motorising said mirror. The methods for controlling the motor are identical to those previously described by reference to other embodiments.

The apparatus 30 is operated in a similar way to those previously described by reference to other embodiments.

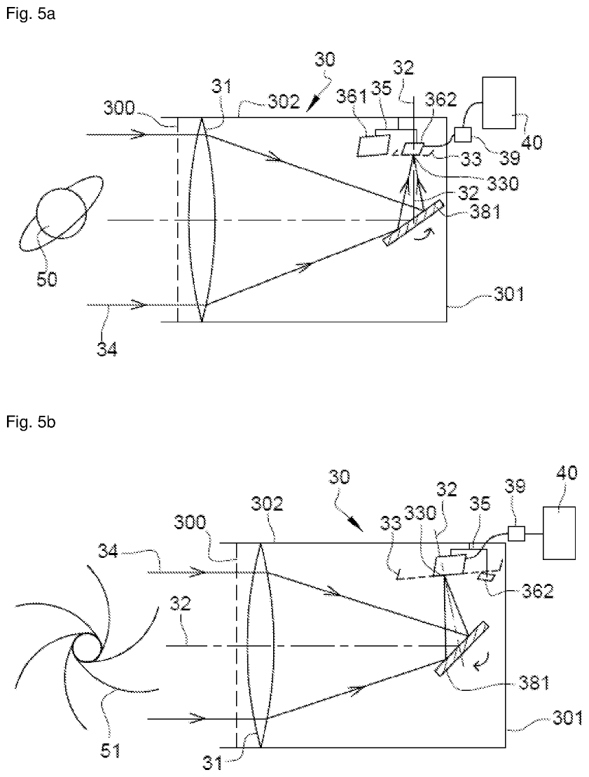

### Fourth Embodiment (FIGS. 5a and 5b)

This embodiment is similar to the third embodiment: the image focal region 330 is movable and the matrix arrays 361, 362 are fixed. The movable optical element 381 is adapted to vary the position of the image focal region 330.

However, here the matrix arrays 361, 362 are disposed on the same side of the hollow body 302 and for example installed side by side, on a fixed common support 35. In the third embodiment, mirror 381 must pivot 90° between the two inclined positions.

In the configuration of the fourth embodiment, the angular deflection of the mirror 381 is smaller (for example, a few degrees) to activate one or other matrix array 361, 362. The matrix arrays are activated more rapidly.

The activation of the selected matrix arrays 361 or 362 and the operation of the apparatus 30 are identical to those described by reference to the third embodiment.

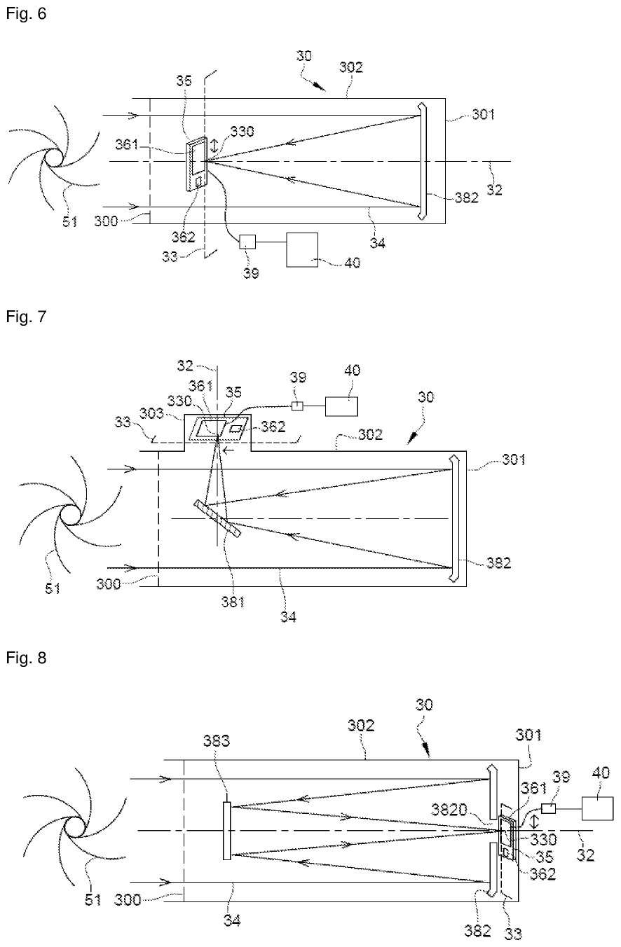

### Fifth Embodiment (FIG. 6)

This embodiment is similar to the second embodiment: the image focal region 330 is fixed and the matrix arrays 361, 362 are movable.

However, the optical system comprises a primary mirror 382 disposed in the hollow body 302, on the side of the second end 301. This primary mirror 382 reflects and makes the light rays 34 converge towards the movable support 35 placed in the image focal region 330.

The movable support 35 on which the matrix arrays 361, 362 are fixed is preferably disposed in the first third of the hollow body 302, on the side of the first end 300 so as not to interfere with the tangent light rays reflected by the primary mirror 382.

Support 35 can be movable by rotation or movable by translation. The activation of selected matrix array 361 or 362 and the operation of apparatus 30 are identical to those previously described, and in which the matrix arrays are movable.

### Sixth Embodiment (FIG. 7)

This embodiment is similar to the fifth embodiment. However, the movable support 35 is installed outside the hollow body 302, in an arrangement 303 made in a wall of said body.

A flat mirror 381, fixed, deflects the light rays 34 reflected by the primary mirror 382, such that the image focal region 330 is located in line with the arrangement. Offsetting the movable support 35 and the matrix arrays 361, 362 outside the hollow body 302 in this way ensures that the opening of the first end 300 is not obscured to allow a maximum of light rays 34 to penetrate. The movable support 35 and the matrix arrays 361, 362 do not interfere with the light rays 34 so that there is no loss of brightness.

Support 35 can be movable by rotation or movable by translation. The activation of selected matrix array 361 or 362 and the operation of apparatus 30 are identical to those previously described, and in which the matrix arrays are movable.

### Seventh Embodiment (FIG. 8)

In this embodiment, the optical system comprises:

a primary mirror 382 positioned in the hollow body 302, to reflect the light rays 34 entering said body,

a secondary mirror 383 positioned in the hollow body 302 to reflect the light rays reflected by the primary mirror 382.

Such an optical system makes it possible to reduce the length of the hollow body 302, while keeping the same focal length of a telescope comprising only one primary mirror 382 (e.g. as illustrated in FIGS. 6 and 7).

The primary mirror 382 and the secondary mirror 383 are on the optical axis 32 that coincides with the axis of symmetry of said hollow body 302. These mirrors are purely reflective.

The primary mirror 382 is preferably a concave parabolic mirror with a low focal ratio (preferably less than 5). This type of mirror makes it possible to overcome spherical aberrations. The diameter of the primary mirror 382 corresponds approximately to the internal diameter of the hollow body 302. The centre of this primary mirror 382 has an aperture 3820 coaxial with the optical axis 32.

The primary mirror 382 is placed close to the second end 301 of the hollow body 302. The secondary mirror 383 is positioned in the hollow body 302, at the first end 300. Installing the secondary mirror 383 inside the hollow body 302 makes it possible to maintain its physical integrity while handling and manipulating the telescope 30.

The secondary mirror 383 is adapted to bring the focal plane 33 behind the primary mirror 382, the reflected light rays passing through the opening 3820. This design reduces the focal length and the length of the hollow body 302 and, consequently, reduces the focal ratio while retaining a primary mirror 382 with a relatively large diameter. The telescope 30 is therefore particularly light and compact.

The secondary mirror 383 can be concave or convex. However, a flat mirror is used in preference. Using a flat mirror offers several advantages. By symmetry, it brings the focal plane 33 back behind the primary mirror 382 and, consequently, the focal length of the optical system. The mirror is also simple in design and inexpensive. The overall cost of the telescope 30 is therefore reduced. In addition, it is easier to align a flat mirror 383 with the primary mirror 382, which reduces assembly time and labour costs. Using a flat mirror also makes it possible to use a secondary mirror with diameter clearly smaller than the primary mirror 382, such that said primary mirror barely obscures the light rays 34 penetrating into the hollow body 302.

To reduce light loss and improve resolution, a flat secondary mirror 383 with smaller diameter is used. According to an advantageous embodiment, the secondary mirror 383 has a diameter half that of the primary mirror 382. Thus, only a small part of the surface area of the primary mirror 382 and of the first end 300 are obstructed. Enough light is then able to penetrate the telescope 30 and be reflected by the primary mirror 382 such that a user can correctly observe large, faint celestial bodies. By way of example, the diameter of the secondary mirror 383 is between 25 mm and 250 mm for a primary mirror 382 with a diameter between 50 mm and 500 mm.

The matrix arrays 361, 362 are disposed in the image focal region 330, such that they interfere neither with the light rays 34 reflected by the primary mirror 382 nor with the light rays reflected by the secondary mirror 383. In this way, the light collected by the active matrix array 361 or 362 is optimised, and the resolution lost due to the presence of the secondary mirror 383 is minimised. In addition, access to the matrix arrays 361, 362 is easier such that they can be installed and/or replaced faster and more easily, without having to manipulate and/or disturb the optical system 382, 383.

In FIG. 8, the focal plane 33 and the image focal region 330 are fixed and the matrix arrays 361, 362 movable.

The support 35 on which the matrix arrays 361, 362 are fixed can be movable by rotation or movable by translation. The activation of selected matrix array 361 or 362 and the operation of apparatus 30 are identical to those previously described, and in which the matrix arrays are movable.

According to another embodiment, the image focal region 330 is movable and the matrix arrays 361, 362 are fixed. In particular, a solution as previously described by reference to the third or fourth embodiment can be envisaged. A movable optical element, a flat mirror, is in this case installed behind the primary mirror 382, to vary the position of the image focal region 330. By varying the inclination of this movable optical element, the light rays reflected by the secondary mirror 383 are deflected, such that the image focal region 330 is located at the first matrix array 361 or the second matrix array 362. These matrix arrays can be disposed on opposite sides, as in the third embodiment. The activation of the selected matrix arrays 361 or 362 and the operation of the apparatus 30 are then identical to those stated previously by reference to the third embodiment. Matrix arrays 361 and 362 can also be installed on the same side, as in the fourth embodiment. The activation of the selected matrix arrays 361 or 362 and the operation of the apparatus 30 are then identical to those stated previously by reference to the fourth embodiment.

### Eighth Embodiment (FIG. 9)

This embodiment is similar to the second embodiment: the image focal region 330 is fixed and the matrix arrays are movable.

However, the movable support 35 comprises three distinct matrix arrays. The third matrix array 363 has a different design from the first matrix array 361 and the second matrix array 362. The third matrix array 363 is an intermediate size and is suitable for observing celestial bodies that are large (e.g. nebulae) but smaller than other larger celestial bodies such as galaxies (the first matrix array 361 is better suited for observing this type of celestial body). For example, its surface area is between 1.5 mm ² and 0.5 cm ². For example, its pixels have sides between 2 μm and 5 μm long.

Support 35 can be movable by rotation or movable by translation. The activation of selected matrix array 361, 362 or 363 and the operation of apparatus 30 are identical to those previously described, and in which the matrix arrays are movable.

According to variant embodiment, the image focal region 330 is movable and the matrix arrays 361, 362, 363 are fixed. In this case, a movable optical element of the optical system is provided to vary the position of the image focal region 330. The activation of selected matrix array 361, 362 or 363 and the operation of apparatus 30 are identical to those previously stated, and in which the matrix arrays are fixed.

### Ninth Embodiment (FIG. 10)

This embodiment is similar to the first embodiment: the image focal region 330 is fixed and the matrix arrays 361, 362 are movable by rotation.

The movable support 35 here is movable by rotation around an axis of rotation 351 that is parallel to the focal plane 33 and perpendicular to the optical axis 32. For example, the movable support 35 can take the form of a cylinder, a drum or another shape. The active matrix array is located in the image focal region 330, in the focal plane 33 and on the optical axis 32, while the inactive matrix array is located outside the focal plane and on said optical axis.

The activation of selected matrix array 361, 362 or 363 and the operation of apparatus 30 are identical to those previously stated, and in which the matrix arrays are movable by rotation.

One or more characteristics disclosed only in one embodiment may be combined with one or more other characteristics disclosed only in another embodiment.

The arrangement of the different elements and/or means and/or steps of the invention, in the embodiments described above, must not be understood as requiring such an arrangement in all implementations. Other variants may be provided, in particular:

the movable optical element 381 is not necessarily a flat mirror but can be a convex mirror, or a reflective element, for example a reflective plate.

in the seventh embodiment, the secondary mirror 383 can be configured to bring the focal plane 33 between the primary mirror 382 and said secondary mirror. The matrix arrays 361, 362 are then arranged to be able to be placed in this focal plane.

1-22. (canceled)

23. A method for acquiring an image of a celestial body, comprising the steps of:
using an apparatus comprising a hollow body into which light rays originating from an observed celestial body penetrate, the celestial body observed being chosen from among at least a first celestial body of a first nature and a second celestial body of a second nature, the nature of the first celestial body being different from the nature of the second celestial body,
arranging, in the hollow body, an optical system having an optical axis, wherein the optical system is configured so that the light rays form an image of the observed celestial body in an image focal region located in a focal plane, arranging, in the hollow body, at least first and second matrix arrays of optical sensors each comprising multiple pixels configured to acquire the image of the first celestial body and the second celestial body, formed in the image focal region, wherein the matrix arrays have pixels of different sizes from each other, and
selecting one of the matrix arrays and placing it in the image focal region, the other matrix array remaining outside of the image focal region, either the first celestial body of the first nature or the second celestial body of the second nature being selected depending on the nature of the observed celestial body.

24. The method according to claim 23, wherein the first and second matrix arrays extend into the focal plane during all steps of the method.

25. The method according to claim 24, wherein the step of selecting one of the matrix arrays is performed by translating one and/or other of the matrix arrays so one of the matrix arrays is placed in the image focal region.

26. The method according to claim 23, wherein the step of selecting one of the matrix arrays is performed by translating one and/or other of the matrix arrays so one of the matrix arrays is placed in the focal plane.

27. The method according to claim 23, further comprising the steps of:
fixing the matrix arrays on a movable support, and moving the movable support to place the selected matrix array in the image focal region.

28. The method according to claim 27, further comprising the steps of:
motorising the movable support by means of a motor, and controlling the motor to move the movable support.

29. The method according to claim 23, further comprising the steps of:
installing the matrix arrays in fixed positions,
using an optical system comprising an optical element that is movable so as to vary the position of the image focal region, and
moving the movable optical element so as to bring the image focal region back to the matrix array selected.

30. The method according to claim 29, further comprising the steps of:
motorising the movable optical element using a motor, and
controlling the motor to move the movable optical element.

31. The method according to claim 28, further comprising the steps of:
connecting the motor to a processing unit, and
controlling the motor:
by activating one or more buttons disposed on the apparatus and connected to the processing unit, or
by transmitting control instructions to the processing unit, which instructions are sent from a smartphone.

32. The method according to claim 28, further comprising the steps of:
saving, in a database, records of celestial bodies, each record being associated with one of the matrix arrays and with real-time location data for the celestial body,
selecting, in the database, a celestial body record,
controlling the motor depending on the matrix array associated with the selected record, and
automatically orienting the apparatus towards the location of the celestial body based on the location data associated with the selected record.

33. The method according to claim 28, further comprising the steps of:
acquiring an image of a celestial body observed in an observation scene, wherein the acquisition is carried out by means of one of the matrix arrays selected according to the nature of the celestial body,
executing a computerised process configured to detect the movement of another celestial body in the observation scene,
selecting the other matrix array, and
controlling the motor depending on the other matrix array selected.

34. The method according to claim 28, further comprising the steps of:
saving, in a database, records of celestial bodies, each record being associated with one of the matrix arrays and at least one characteristic element of the celestial body,
acquiring an image of a celestial body, wherein the acquisition is carried out by means of one of the matrix arrays,
executing a computerised recognition process configured to detect, in the image acquired, at least one characteristic element of the celestial body,
identifying, in the database, a record of a celestial body associated with a characteristic element similar to the detected characteristic element,
selecting the matrix array associated with the record identified, and
if the matrix array that acquired the image does not match the matrix array selected, then controlling the motor according to the selected matrix array.

35. An apparatus for acquiring an image of a celestial body comprising:
a hollow body into which light rays originating from an observed celestial body penetrate, the celestial body observed being chosen from among at least a first celestial body of a first nature and a second celestial body of a second nature, the nature of the first celestial body being different from the nature of the second celestial body,
an optical system arranged in the hollow body and having an optical axis, wherein the system is configured so that the light rays form an image of the observed celestial body in an image focal region located in a focal plane,
at least first and second matrix arrays of optical sensors each comprising multiple pixels configured to acquire the image of the first celestial body and the second celestial body, formed in the image focal region, wherein the matrix arrays have pixels of different sizes from each other, and
a device for selecting appropriate matrix arrays to place one of the two matrix arrays in the image focal region, the other matrix array remaining outside the image focal region, so that the celestial body observed is the first celestial body of first nature or the second celestial body of second nature.

36. The apparatus according to claim 35, wherein the first matrix array and the second matrix array have different sizes.

37. The apparatus according to claims 35, wherein the image focal region is fixed and the matrix arrays are movable.

38. The apparatus according to claims 35, wherein the matrix arrays are fixed to a support that is movable between:
a first position in which the first matrix array is placed in the image focal region, and in which the second matrix array is placed outside said image focal region, and
a second position in which the second matrix array is placed in the image focal region, and in which the first matrix array is placed outside said image focal region.

39. The apparatus according to claim 38, wherein the support is movable by rotation or movable by translation.

40. The apparatus according to claims 35, wherein the matrix arrays are fixed and the image focal region is movable.

41. The apparatus according to claim 40, wherein the optical system includes an optical element that is movable so as to vary the position of the image focal region.

42. The apparatus according to claim 41, wherein the optical element is movable between:
a first position in which the image focal region is brought back to the first matrix array, and
a second position in which the image focal region is brought back to the second matrix array.

43. The apparatus according to claim 35, wherein the optical system further comprises:
a primary mirror positioned in the hollow body to reflect the light rays entering the body, and
a secondary mirror positioned in the hollow body to reflect the light rays reflected by the primary mirror, wherein the secondary mirror is adjusted to bring the focal plane behind the primary mirror,
wherein the matrix arrays are arranged behind the primary mirror.

44. The apparatus according to claim 35, in the form of a telescope.
